(19) United States
(12) Patent Application Publication
(10) Pub. No.: US 2024/0214883 A1
(43) Pub. Date: Jun. 27, 2024

(54) ENHANCED RELAYING IN CELLULAR COMMUNICATION NETWORKS

(71) Applicant: Nokia Technologies Oy, Espoo (FI)

(72) Inventors: Rudraksh SHRIVASTAVA, Stuttgart (DE); Sudeep HEGDE, Stuttgart (DE); Vinh VAN PHAN, Oulu (FI); Berthold PANZNER, Munich (DE)

(21) Appl. No.: 18/291,440

(22) PCT Filed: Jun. 23, 2022
(86) PCT No.: PCT/EP2022/067114

§ 371 Date: Jan. 23, 2024

(30) Foreign Application Priority Data
Aug. 2, 2021 (FI) 20215829

(51) Int. Cl. H04W 36/00

(52) U.S. Cl. CPC H04W 36/0077

(57) ABSTRACT

According to an example aspect of the present disclosure, there is provided an apparatus comprising means for receiving, at the apparatus, an indication indicating that a target base station of the apparatus for a handover does not support relaying, wherein the apparatus is in a radio resource control connected state and has a relay link with a serving base station via a relay user equipment and pausing the relay link based at least on the received indication.

### FIELD

Various example embodiments relate in general to cellular communication networks and more specifically, to relaying in such networks.

### BACKGROUND

Relaying may refer to a communication, wherein at least one communication device forwards information between other communication devices. For instance, in a cellular communication network one User Equipment, UE, may act as a relay between another UE and a Base Station, BS. Relaying may be enabled in various cellular communication networks, such as in cellular communication networks operating according to 5G radio access technology. 5G radio access technology may also be referred to as new radio, NR, access technology. 3rd generation partnership project, 3GPP, develops standards for 5G/NR and some topics in the 3GPP discussions are related to relaying. According to the discussions there is a need to provide improved methods, apparatuses and computer programs related to relaying. Such improvements may be exploited in other cellular communication networks as well.

### SUMMARY

According to some aspects, there is provided the subject-matter of the independent claims. Some example embodiments are defined in the dependent claims.

The scope of protection sought for various example embodiments of the present disclosure is set out by the independent claims. The example embodiments and features, if any, described in this specification that do not fall under the scope of the independent claims are to be interpreted as examples useful for understanding various example embodiments of the present disclosure.

According to a first aspect of the present disclosure, there is provided an apparatus, comprising means for receiving, at the apparatus, an indication indicating that a target base station of the apparatus for a handover does not support relaying, wherein the apparatus is in a radio resource control connected state and has a relay link with a serving base station via a relay user equipment and pausing the relay link based at least on the received indication. The apparatus of the first aspect may comprise the remote user equipment, or a control device configured to control the functioning thereof, possibly when installed therein.

Example embodiments of the first aspect may comprise at least one feature from the following bulleted list or any combination of the following features:
wherein pausing the relay link comprising, transmitting to the serving base station, a radio resource control message to request a transition from the radio resource control connected state to a radio resource control inactive state, wherein a context of the apparatus in the radio resource control inactivate state is associated with the relay user equipment and the relay link and transitioning from the radio resource control connected state to the radio resource control inactive state;
means for receiving a radio network temporary identifier from the serving base station, wherein the radio network temporary identifier is to be used to identify a pair comprising the apparatus and the relay user equipment;
means for buffering uplink data while the relay link is paused;
means for starting a timer when pausing the relay link, wherein the timer is configured by the relay user equipment or the serving base station;
means for receiving an indication indicating that a subsequent target base station for a subsequent handover supports relaying and resuming the relay link with the subsequent target base station via the relay user equipment by using the allocated radio network temporary identifier;
stopping the timer upon receiving the indication indicating that the subsequent target base station for the subsequent handover supports relaying when the timer is running;
means for requesting the relay user equipment or the serving base station to extend the timer;
means for, upon expiration of the timer, terminating the relay link.
means for terminating the relay link based at least on the received indication indicating that the target base station for the handover does not support relaying;
wherein the termination of the relay link comprising at least one of the following:
a. initiating a re-selection of another relay user equipment;
b. establishing a direct connection between the apparatus and a base station; and
c. transitioning to a radio resource control idle state.

According to a second aspect of the present disclosure, there is provided an apparatus, comprising means for receiving, at the apparatus from a serving base station, an indication indicating that a target base station of the apparatus for a handover does not support relaying, wherein the apparatus relays a relay link of a remote user equipment to the serving base station and the remote user equipment is in a radio resource control connected state, forwarding the indication to the remote user equipment and receiving, from the remote user equipment, a request for pause of the relay link. The apparatus may comprise the relay user equipment, or a control device configured to control the functioning thereof, possibly when installed therein.

Example embodiments of the second aspect may comprise at least one feature from the following bulleted list or any combination of the following features:
transmitting to the serving base station, a radio resource control message to request for transitioning the remote user equipment from the radio resource control connected state to the radio resource control inactive state;
receiving a radio network temporary identifier from the serving base station, wherein the radio network temporary identifier is to be used to identify a pair comprising the apparatus and the remote user equipment;

According to a third aspect of the present disclosure, there is provided an apparatus, comprising means for determining that a target base station for a handover of a relay user equipment does not support relaying and transmitting, to a relay user equipment and/or a remote user equipment, an indication indicating that the target base station for the handover does not support relaying, wherein the remote user equipment is in a radio resource control connected state and has a relay link with the apparatus via the relay user equipment.

In some embodiments, the apparatus of the third aspect may further comprise means for receiving a radio resource control message to request a state transition for the remote user equipment from the radio resource control connected state to a radio resource control inactive state, allocating a radio network temporary identifier, wherein the radio network temporary identifier is to be used to identify a pair comprising the remote user equipment and the relay user equipment and sending the radio network temporary identifier to the relay user equipment and/or the remote user equipment.

According to a fourth aspect of the present disclosure, there is provided a first method, comprising receiving, at an apparatus, an indication indicating that a target base station of the apparatus for a handover does not support relaying, wherein the apparatus is in a radio resource control connected state and has a relay link with a serving base station via a relay user equipment and pausing the relay link based at least on the received indication. The first method may be performed by the remote user equipment, or a control device configured to control the functioning thereof, possibly when installed therein.

According to a fifth aspect of the present disclosure, there is provided a second method, comprising receiving, at an apparatus from a serving base station, an indication indicating that a target base station of the apparatus for a handover does not support relaying, wherein the apparatus relays a relay link of a remote user equipment to the serving base station and the remote user equipment is in a radio resource control connected state, forwarding the indication to the remote user equipment and receiving, from the remote user equipment, a request for pause of the relay link. The second method may be performed by the relay user equipment, or a control device configured to control the functioning thereof, possibly when installed therein.

According to a sixth aspect of the present disclosure, there is provided a third method, comprising determining that a target base station for a handover of a relay user equipment does not support relaying and transmitting, to a relay user equipment and/or a remote user equipment, an indication indicating that the target base station for the handover does not support relaying, wherein the remote user equipment is in a radio resource control connected state and has a relay link with the apparatus via the relay user equipment. The third method may be performed by a base station, or a control device configured to control the functioning thereof, possibly when installed therein.

According to a seventh aspect of the present disclosure, there is provided an apparatus comprising at least one processing core, at least one memory including computer program code, the at least one memory and the computer program code being configured to, with the at least one processing core, cause the apparatus at least to receive, at the apparatus, an indication indicating that a target base station of the apparatus for a handover does not support relaying, wherein the apparatus is in a radio resource control connected state and has a relay link with a serving base station via a relay user equipment and pause the relay link based at least on the received indication. The apparatus may comprise a remote user equipment, or a control device configured to control the functioning thereof, possibly when installed therein

According to an eighth aspect of the present disclosure, there is provided an apparatus comprising at least one processing core, at least one memory including computer program code, the at least one memory and the computer program code being configured to, with the at least one processing core, cause the apparatus at least to receive, at the apparatus from a serving base station, an indication indicating that a target base station of the apparatus for a handover does not support relaying, wherein the apparatus relays a relay link of a remote user equipment to the serving base station and the remote user equipment is in a radio resource control connected state, forward the indication to the remote user equipment and receive, from the remote user equipment, a request for pause of the relay link. The apparatus may comprise a relay user equipment, or a control device configured to control the functioning thereof, possibly when installed therein.

According to an ninth aspect of the present disclosure, there is provided an apparatus comprising at least one processing core, at least one memory including computer program code, the at least one memory and the computer program code being configured to, with the at least one processing core, cause the apparatus at least to perform, determine that a target base station for a handover of a relay user equipment does not support relaying and transmit, to a relay user equipment and/or a remote user equipment, an indication indicating that the target base station for the handover does not support relaying, wherein the remote user equipment is in a radio resource control connected state and has a relay link with the apparatus via the relay user equipment. The apparatus may comprise a base station, or a control device configured to control the functioning thereof, possibly when installed therein.

According to a tenth aspect of the present disclosure, there is provided a non-transitory computer readable medium having stored thereon a set of computer readable instructions that, when executed by at least one processor, cause an apparatus to at least perform the first, the second or the third method. According to an eleventh aspect of the present disclosure, there is provided a computer program comprising instructions which, when the program is executed by an apparatus, cause the apparatus to carry out the first, the second or the third method.

### BRIEF DESCRIPTION OF THE DRAWINGS

FIG. 1 illustrates an example of a communication network in accordance with at least some example embodiments;

FIG. 2 illustrates an example of connection states for a remote UE in accordance with at least some example embodiments;

FIG. 3 illustrates a signalling graph in accordance with at least some example embodiments;

FIG. 4 illustrates an example apparatus capable of supporting at least some example embodiments;

FIG. 5 illustrates a flow graph of a first method in accordance with at least some example embodiments;

FIG. 6 illustrates a flow graph of a second method in accordance with at least some example embodiments; and

FIG. 7 illustrates a flow graph of a third method in accordance with at least some example embodiments.

### EXAMPLE EMBODIMENTS

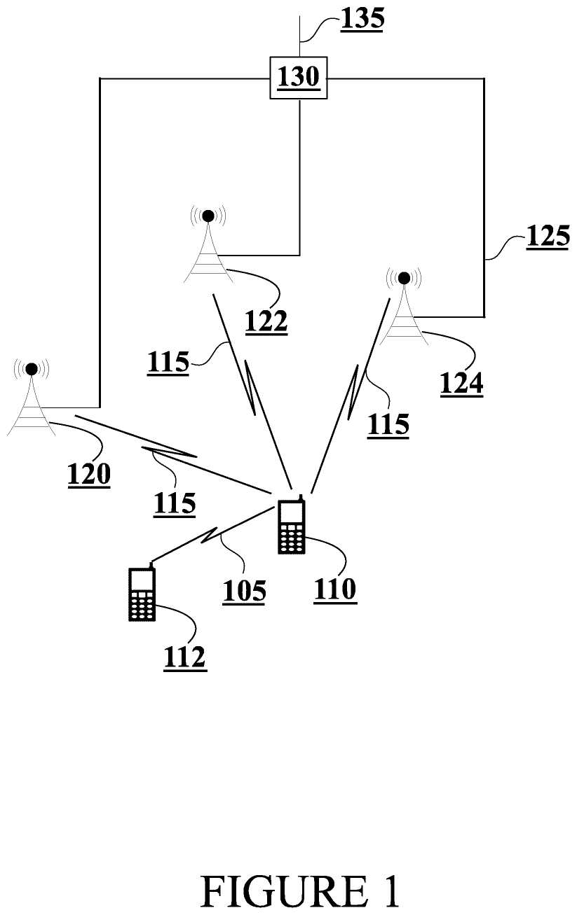

FIG. 1 illustrates an example of a communication network in accordance with at least some example embodiments. According to the example scenario of FIG. 1, the cellular communication network may comprise relay User Equipment, UE 110, remote UE 112 and Base Stations, BSs, 120, 122 and 124. In addition, the cellular communication network may comprise core network 130. Relay UE 110 and remote UE 112 may be connected to each other via air interface 105. Relay UE 110 may be further connected to BS 120, or some other BS, via air interface 115. Remote UE 112 may not be connected to BS 120 directly but remote UE 112 may be connected to BS 120 via relay UE 110. That is, there may be a relay link between remote UE 112 and BS 120 and remote UE 112 and BS 120 with each other via the relay link comprising air interfaces 105 and 115. In addition, there may be a L2 relay connection between relay UE 110 and remote UE 112 over air interface 105.

Relay UE 110 and remote UE 112 may comprise, for example, a smartphone, a cellular phone, a Machine-to-Machine, M2M, node, Machine-Type Communications, MTC, node, an Internet of Things, IoT, node, a car telemetry unit, a laptop computer, a tablet computer or, indeed, any kind of suitable wireless terminal. BS 120 may be a network entity that configures some or all control information and allocates at least some resources for relay UE 110 and remote UE 112. In some example embodiments, BS 120 may be considered as a serving BS for at least relay UE 110, and possibly for remote UE 112 as well. BS 122 may be a target BS for a first, upcoming handover of relay UE 110 while BS 124 may be a target BS for a second handover, subsequent to the first handover.

Serving BS 120 and second target BS 124 may support both, L2- and L-3 relaying while first target BS 122 may support L2-relaying but not L-3 relaying. For instance, L2 relay may be visible to Radio Access Network, RAN, while L3 Relay may not be. L2 relay may be controlled by BS 120 while L3 relay may be controlled by a node in core network 130.

Air interface 105 between relay UE 110 and remote UE 112 may be configured in accordance with a Radio Access Technology, RAT, which relay UE 110 and remote UE 112 are configured to support. Similarly, air interface 115 between for example relay UE 110 and BS 120 may be configured in accordance with a RAT which and relay UE 110 and BS 120 are configured to support. Examples of cellular RATs include Long Term Evolution, LTE, New Radio, NR, which may also be known as fifth generation, 5G, radio access technology and MulteFire. A cellular RAT may be standardized by the 3^{rd} Generation Partnership Project, 3GPP, for example. Hence, relay UE 110 and remote UE 112, and BS 120 as well, may be configured to operate according to the 3GPP standards. A RAN may comprise UEs 110, 112 and BS 120, 122, 124.

BSs 120, 122, 124 may be connected, directly or via at least one intermediate node, with core network 130 via wired interface 125. Core network 130 may be, in turn, coupled via interface 135 with another network (not shown in FIG. 1), via which connectivity to further networks may be obtained, for example via a worldwide interconnection network.

At least some example embodiments of the present disclosure are related to using SL based UE-to-UE communication between relay UE 110 and remote UE 112. A SL may refer to a direct communication link between relay UE 110 and remote UE 112 in a cellular communication network. Relay UE 110 and remote UE 112 can communicate via the SL without going through BS 120. SL communications may be performed over PC5 for example, as described for example in 3GPP TS 36.400 for LTE and 3GPP TS 38.400 for NR, based on a principle of a transmitter oriented one-to-many broadcast/groupcast communication and/or one-to-one unicast communication.

Embodiments of the present disclosure address various issues. For instance, objectives on aspects common to both, L2- and L3-relaying, comprise specifying mechanisms for UE-to-Network, U2N, relay discovery and (re)selection for L3- and L2-relaying. In addition, objectives specific to L2-relaying comprise specifying control plane procedures for U2N, such as Radio Resource Control, RRC, connection management, system information delivery, paging mechanism and access control for remote UE 112.

An inactive state, such as RRC_INACTIVE state or mode, may refer to a state wherein a UE may remain in Connection Management, CM-CONNECTED, state and move within an area configured by a network, like a RAN based Notification Area, RNA, without notifying the network. In the inactive state, the last serving BS, such as serving BS 120, may keep context of the UE and the UE-associated connection with a serving Access and Mobility Management Function, AMF, and User Plane Function, UPF.

If a last serving BS, such as BS 120, receives downlink data from the UPF or downlink UE-associated signalling from the AMF (except the UE Context Release Command message) while the UE is in inactivate state, the last serving BS may page in cells corresponding to the RNA and may send XnAP RAN Paging to neighbour BS(s) if the RNA includes cells of neighbour BS(s). Moreover, a UE in the inactive state may be configured by the last serving BS with an RNA, wherein:
the RNA may cover a single or multiple cells, and be contained within the CN registration area, e.g., Xn connectivity may be available within the RNA;
a RAN-based notification area update may be periodically sent by the UE and also sent when the cell reselection procedure of the UE selects a cell that does not belong to the configured RNA.

The RNA may be configured in various ways, such as:
a list of cells, e.g., an explicit list of cells (one or more) that constitute the RNA may be provided to the UE;
a list of RAN areas, e.g., (at least one) RAN area ID may be provided to a UE, where a RAN area may be a subset of a CN Tracking Area or equal to a CN Tracking Area. A RAN area may be specified by one RAN area ID, which may comprise of a TAC and optionally a RAN area Code. A cell may for example broadcast one or more RAN area IDs in the system information.

Embodiments of the present disclosure may be applied at least in a scenario, wherein relay UE 110 and remote UE 112 move as a pair and have an on-going L2 relay link with BS 120, as shown in FIG. 1. Remote UE 112 may be in a connected state, such as in RRC_CONNECTED state or mode, to BS 120 via the L2 relay link, i.e., via relay UE 110. Therefore, relay UE 110 may have a direct connection with the network via air interface 115, like a Uu connection with BS 120. While moving, relay UE 110 and remote UE 112 may come across a target BS for a handover, such as BS 122, wherein the target BS for the handover does not support L2-relaying. That is, BS 122 may be a BS which is not L2 relay capable. So if relay UE 110 is handed over to BS 122, a relay service to remote UE 112 may no longer be possible using the existing L2 relay link. If the L2 relay connection between relay UE 110 and remote UE 112 would then be released, remote UE 112 may perform relay discovery and reselection procedure to find another suitable relay UE. Alternatively, remote UE 112 may try to establish a direct connection over air interface 115, such as Uu link, to the network.

However, if there are several BSs in the vicinity of remote UE 112 and some of those BSs may support L2-relaying (excluding the target BS for the handover of relay UE 110) the following disadvantages may occur:
Following the handover of Relay UE 110 to the target BS, such as BS 122 in FIG. 1, relay UE 110 may perform a subsequent handover to another target BS, such as BS 124, wherein said another target BS may support L2 relaying. In this case, if the L2 connection to remote UE 112 and the L2 relay link to the network have been released already, remote UE 112 would need to perform again the relay discovery procedure and may discover same relay UE 110 to support its transmissions using a L2 relay link. For example, when remote UE 112 is out-of-coverage (on a high-speed train or down in the basement) and needs to rely on relay UE 112 to get connected to the network, remote UE 112 has no alternative but to follow relay UE 110.
Following the handover of Relay UE 110 to the target BS, such as BS 122 in FIG. 1, if relay UE 110 and/or remote UE 112 chooses to establish a L3 relay link to continue relaying, establishment of the L3 relay link maybe wasteful, if a BS which supports L2 relaying, such as BS 124, is available within a short time duration after setting up the L3 relay link;
Repeated relay reselection or Uu reestablishment in short durations of time may introduce significant service interruptions for remote UE 112 and also cause increased signaling for the network, e.g., when there are several BSs in the vicinity of the Remote-UE/Relay-UE pair, with different capabilities with respect to supporting L2/L3 relaying.
If remote UE 112 does not know that a L2 relay UE, such as relay UE 110, is not available locally and/or temporarily, remote UE 112 may try to discover L2 relay UEs again in its relay reselection procedure. So if remote UE 112 cannot find a suitable relay, additional signaling overhead and power wastage may be caused.

Embodiments of the present disclosure therefore make it possible to efficiently preserve the L2 relay connection between relay UE 110 and remote UE 112 and the L2 relay link between remote UE 112 and BS 120, to avoid causing unnecessary signaling overhead and power wastage. A short and temporary unavailability of the L2 relay link due to lack of network support and other related problems may occur for example in scenarios involving, e.g., wearables or Vehicle-to-Everything, V2X, platooning/group communications scenarios, wherein multiple UE(s) may be within a vehicle and the vehicle may act as relay UE 110. Hence, at least in such scenarios it necessary to handle relay UE 110 and remote UE 112 efficiently.

If a target BS for a handover of relay UE 110, such as BS 122, does not support L2-relaying, a serving BS of relay UE 110, such as BS 120, may transmit to relay UE 110 an indication indicating that the target BS for the handover does not support L2-relaying. Said indication may be transmitted when remote UE 111 is in a connected state and has a L2 relay connection with relay UE 110 and a L2 relay link with BS 120, via the L2 relay connection. Even though the L2 relay link and the L2 relay connection are used as an example, embodiments of the present invention may be applied for any relay and any relay connection. Similarly, even though L3 connection is used as an example, embodiments of the present invention may be applied for any other relay connection as well.

In some embodiments, said indication may be referred to as a no-L2-support indication and it may indicate discontinued support at the target BS. In some embodiments, relay UE 110 may forward said indication to remote UE 112. Alternatively, or in addition, a list of BSs supporting L2-relaying, e.g., at a location of remote UE 112, may be provided to remote UE 112 by BS 120, for example as pre-configuration or in the RNA updates.

In some embodiments, relay UE 110 may indicate L2/L3-relaying capability of the target BS and also any additional BSs if relay UE 110 is aware of the route plan and knows which BSs along the route support L2/L3-relaying functionalities or the report of HO prediction. Relay UE 110 may be informed by the network about the BSs capability in different ways for, or during, the route planning, or using Xn interface/HO command (using neighbour cell list) or via System Information Block, SIB, and/or dedicated signalling or via RNA cell list, possibly together with a HO indication over the L2 connection, such as sidelink, or separately in an implicit or explicit manner. This This HO indication is basically telling the UE that there is going be an handover to another gNB.

A new element in the RNA cell list may indicate L2/L3 sidelink relay capability for BSs within an area. This way even the UEs that are in inactive state may get updates/information related to L2/L3-relaying capabilities of the BSs. This may be done implicitly, e.g., the target BS only indicates if it is L2-capable but there is no indication if the target BS is not L2-capable.

Upon reception of said indication, relay UE 110 and remote UE 112 may determine to pause, and pause, the ongoing L2 relay link and the L2 connection, such as a SL connection, between relay UE 110 and remote UE 112. Remote UE 112 may determine to pause based on its QoS requirements, it can receive an indication from the network or relay UE 110 to temporarily pause the link or the determination may be up to implementation.

In some embodiments, relay UE 110 and remote UE 112 may keep the L2 relay link and the L2 connection in the paused state, e.g., until L2-relaying is available, possibly at another target BS for a subsequent handover, such as BS 124. The paused state may be associated with a L2-pause timer, i.e., relay UE 110 and/or remote UE 112 may start L2 pause timer when the L2 relay link and the L2 connection between relay UE 110 and remote UE 112 is paused. The L2 pause state may be defined as a state where the L2 UE-to-Network connection is temporarily put on hold or halted due to lack of L2 capability of target BS 122.

If configured, the L2 pause timer may be triggered for managing the paused L2 relay link between remote UE 112 and the network, such as BS 120, and the L2 connection between relay UE 110 and remote UE 112. The duration of the L2 pause timer may be configured based on a prediction of entering L2 capable BSs, handover prediction or based on the delay constraints, such as remaining Packet Delay Budget, PDB, and/or total PDB of the on-going L2 session, desired Quality of Service, QoS, power saving (e.g. if the UE(s) power saving constraints allow it) etc.

The L2 pause timer maybe configured and run by relay UE 110, remote UE 112 and/or the network, such as BS 120. The value of the L2 pause timer maybe dynamically configured or adapted based on the on-going situation. Based on the L2 pause timer, relay UE 110 and/or remote UE 112 may perform RRC state transitions and manage the relay connection, such as PC5, and/or Uu link.

If the L2 pause timer expires, one or more of the following actions may be performed:
relay UE 110 and/or remote UE 112 may coordinate to extend the duration of the L2 pause timer duration and inform the network;
remote UE 112 may initiate relay re-selection (e.g., with preference to L3-relaying or on-going L3);
remote UE 112 may switch to direct Uu Path, with or without an explicit notification from relay UE 110;
relay UE 110 may terminate the L2 relay link and provide the service via another relay link, like a newly established L3 relay link;
L2 relay connection, such as PC5, may be terminated and remote UE 112 is out-of-coverage or in an idle state;
relay UE 110 may inform the network about the discontinuing the relay service to remote UE 112.

If a L2-capable BS, such as BS 122, is available again and the L2 pause timer running on relay UE 110 and/or remote UE 112 has not expired, relay UE 110 may transmit a command to remote UE 112 to stop the L2 pause timer and resume the L2 relay link and the L2 relay connection, and transmit/receive the buffered traffic. In some embodiments, receiving a transmission from relay UE 110 on the paused L2 relay connection may be considered as an implicit trigger by remote UE 112 to stop the L2 pause timer.

In some embodiments, when the L2 pause timer is running on remote UE 112, remote UE 112 may sort delay sensitive data and transmit said data over a new L3 session or via Uu without terminating pausing of the L2 relay link and the L2 relay connection. This functionality may be stopped when a command is received from relay UE 110 to stop the L2 pause timer, the command indicating the availability of L2 capable BS. In another embodiment, remote UE 112 in idle state may be switched to an inactive state on Uu to resume Uu if the L2 pause timer expires.

In another embodiment, relay UE 110 and/or remote UE 112 may request to extend the duration of the L2 pause timer and inform each other about the extension. Extending the duration of the L2 pause timer may comprise for example adding time to the timer or restarting the timer. Relay UE 110 and/or remote UE 112 may request to extend the duration of the L2 pause timer and inform each other about the extension, e.g., via inter-UE coordination. The extension of the L2 pause timer may be requested by relay UE 110 and/or remote UE 112, or also be enforced by, or informed to, the network. During the pausing of the L2 relay link or running the L2 pause timer, relay UE 110 and remote UE 112 may be supposed to maintain their L1 connection, such as SL connection (at least on the keep-alive basis).

In another embodiment, no L2 pause timer may be used. Instead, relay UE 110 may transmit a trigger command to remote UE 110, either together with the HO indication over the sidelink or separately in an implicit or explicit manner. If remote UE 112 receives the trigger command from relay UE 110, remote UE 110 may make an appropriate decision to conduct a specific action, e.g., switching to the inactive state. In such a case, remote UE 112 may or may not release the sidelink connection to the relay UE 110. Remote UE 112 itself may release the sidelink link if the L2 relay link and the L2 relay connection is not provided for an extended time duration and/or if remote UE 112 cannot postpone the data transmission or reception or if the power saving rules does not allow. Then, remote UE 112 may perform relay re-selection/Relay discovery or switch to Uu link or switch to L3 UE-to-NW Relay link.

In some embodiments, relay UE 110 may indicate specific or targeted actions to remote UE 112 such as release of a PC5 relay link and/or trigger the switch to Uu connected state or re-select a relay UE or switch to L3 UE-to-NW Relay link. Such an indication may also be provided by the network or it can be pre-configured by the network. This may be independent to whether the pause timer-based approach is used or not, and may be applied to both timer- and non-timer-based scenarios.

For example, when relay UE 110 and remote UE 112 move further apart, remote UE 112 may be required to release the L2 relay connection, e.g., after the expiry of the timer if configured or through an explicit indication from relay UE 110. In some embodiments, absolute or relative positioning of remote UE 112 and relay UE(s) 110 may be used by the involved entities to make decisions.

In some embodiments, when the decision to pause the L2 relay link is taken, relay UE 110 and/or remote UE 112 may transmit a RRC suspend request to the network, such as BS 120, to suspend the RRC connection, or state, of remote UE 112. That is, relay UE 110 and/or remote UE 112 may transmit a RRC suspend request, to suspend the RRC connection, or state, between remote UE 112 and the network. In some embodiments, the RRC suspend request may comprise a cause value corresponding to L2-pause, i.e., indicating that the L2 relay link and the L2 relay connection have been paused. The network, such as BS 120, may transmit to remote UE 110 a RRC suspend command responsive to receiving the RRC suspend request. Upon receiving the command, remote UE 112 may transition from the connected state to an inactive state. In some embodiments, said transitioning may be to an idle state, such as RRC_IDLE. In case of transition to the idle state, a part of the UE-context and/or UE-SL context may be kept or released after a certain time, and possible a timer maybe configured with an appropriate value if needed.

In some embodiments, relay UE 110 and remote UE 112 may preserve, i.e., store, their identities as a pair and provide the pair of identities also to the network. The identities may be used later by another target BS, such as a L2 capable BS 124, to assist in resuming the L2 relay link. Hence, a relay discovery and re-establishment procedure may be avoided, such a PC-5 re-establishment procedure between relay UE 110 and remote UE 112, to save time and signaling. When the L2 relay link support is available in said another target BS, relay UE 110 may request a new configuration for the L2 relay link and resume the L2 relay link. For instance, upon receiving the RRC suspend request from remote UE 110, the network may modify the access stratum UE context for relay UE 110 and remote UE 112 to also contain information about the paused L2 relay link.

Said another target BS may fetch the context information of the L2 relay link, e.g., the Uu and/or sidelink related access stratum context information of relay UE 110 and remote UE 112, from the old L2 anchor BS, such as BS 120. Said another target BS may then configure and resume the L2 relay link. This can be done considering relay UE 110 and remote ULE 112 as a pair, i.e., by using the identity of relay UE 110 to fetch the context information of the pair. The context information of the L2 relay connection may comprise at least UE IDs, QoS Flow Identifier, QFI, SL QoS configurations/PC5 QoS Identifier, PQI, sidelink measurement data and so on.

In some embodiments, the network may transmit a new type Radio Network Temporary Identifier, RNTI, such as I-RNTI, to each of relay UE 110 and remote UE 112, to be used while the L2 relay link and the L2 relay connection between them are paused. The new type RNTI in question may identify the pair comprising relay UE 110 and remote UE 112. The benefit is to keep the context information of the L2 relay link at the same anchor BS/network, such as BS 120, so that relay UE 110 may request to resume the L2 relay link for remote UE 112 as soon as relay UE 110 may act as a L2 relay UE again. That is, when the support for the L2 relay link becomes available again, e.g., before the L2 pause timer expires if configured. The resume request may also indicate the remaining duration of the pause timer, in addition to the new type RNTIs and IDs of relay UE 110, remote UE 112 and BS 120. The new type RNTI may be different compared to a conventional I-RNTI, because relay UE 110, remote UE 112 and BS 120 may know, based on the received new type RNTI, that the context information of the L2 relay link needs to be preserved, or at least the pair information of relay UE 110 and remote UE 112, such as their IDs, while the L2 relay link is paused. In some embodiments, relay UE 110 may receive a separate conventional I-RNTI for its own RRC connection, depending on the requirement.

In some embodiments, the network may transmit the new type RNTI to relay UE 110 and/or remote UE 110 when relay UE 110 and/or remote UE 110 transition to an in active state to be used while the L2 relay link between them is paused. The context of the L2 relay link may be stored at the network to be used with the new type RNTI when the L2 connection is paused. The network may store the IDs of relay UE 110 and remote UE 112 as a pair along with the access stratum UE contexts, such that the L2 relay link can be quickly resumed when L2 capable BS is again available.

The new type RNTI may comprise a new UE ID for relay UE 110, at least in case relay UE 110 remains in the connected state after the L2-relaying support becomes unavailable. The benefit is to keep the context information of the L2 relay link for both, relay UE 110 and remote UE 112 at the same anchor BS, such as BS 120, so that relay UE 110 may request to resume the L2 relay link for remote UE 112 as soon as relay UE 110 can act as a L2 Relay UE again, i.e., L2-relaying support becomes available again, before the pause timer expires.

Optionally, the SL UE contexts of relay UE 110 and remote UE 112 may be preserved individually at the network and/or at when remote UE 112 enters an inactive state.

In some embodiments, remote UE 112 may buffer uplink data while the L2 relay link and the L2 relay connection are paused, e.g., when the L2 pause timer is running. Alternatively, or in addition, relay UE 110 and/or BS 120 may buffer downlink data while the L2 relay link is paused, e.g., when the L2 pause timer is running. If the sidelink between remote UE 112 and relay UE 110 is active, uplink data of remote UE 112 may optionally be buffered at relay UE 110.

Remote UE 112 may not terminate the L2 relay link between itself and relay UE 110. That is, the L2 connection may be paused without terminating the link. Only relay UE 110 and remote UE 112 may be allowed to resume the RRC connection of remote UE 112 while the L2 relay link is paused. BSs may be configured to not initiate paging for relay UE 110 and remote UE 112 while the L2 relay link is paused. In some embodiments, core network 130 may also be informed about pausing of the L2 relay link, e.g., using RRC inactive transition report, such that paging may be avoided by core network 130 while the L2 relay link is paused.

If another BS supporting L2-relaying is available again, relay UE 110 may then request to resume the RRC connection of Remote UE 112, e.g., using the new type RNTI provided by network.

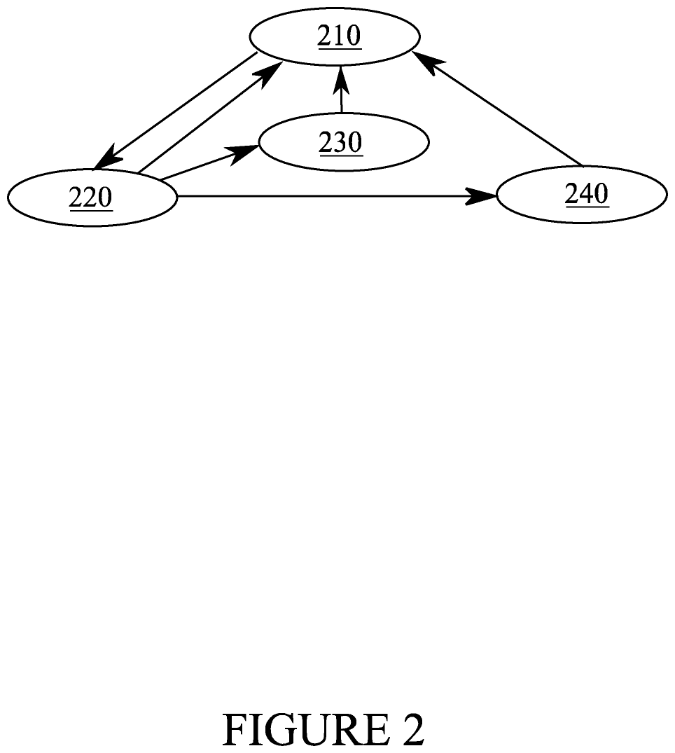

FIG. 2 illustrates an example of connection states for a remote UE in accordance with at least some example embodiments. At step 210, remote UE 112 may be in a connected state, through an ongoing L2 relay link with relay UE 110. Relay UE 110 may perform a handover to a target BS, such as BS 122, which does not support L2-relaying. Relay ULE 110 may then notify remote UE 112 about the handover by transmitting an indication indicating that the target BS does not support L2-relaying. If relay UE 110 notifies remote UE 112 about handing over to the target BS not supporting L2-relaying, remote UE 112 may make an appropriate decision for itself, e.g., send a notification to relay UE 110 for pausing the L2 relay link or accepting to pause and then remote UE 112 may make a transition to an RRC inactive state.

The notification sent by relay UE 110 may have several purposes, such as triggering remote UE 112 Uu state transition, which may be from any RRC state to any RRC state, pausing the on-going L2 UE-to-NW relay link thereby putting the on-going SL to a new inactive like state. In addition, similar command/notification message may also be used to resume PC5 UE-to-NW setup once the L2 capable BS is available again.

In another embodiment, if relay UE 110 is serving more than one remote UE, relay UE 110 may provide customized configuration to individual remote UE(s). Relay UE 110 may move one or more remote UEs to L3 session while keeping remaining remote UEs in the new PC5 L2 inactive state.

After that, at step 220, relay UE 110 and/or remote UE 112 may transmit a RRC suspend/Release request to suspend the RRC connection between remote UE 112 and the network and to transition remote UE 112 to the in active state. Relay UE 110 and remote UE 112 may then start a L2 pause timer (if configured) and the L2 relay connection between relay UE 110 and remote UE 112 may be paused. Once the decision is taken by remote UE 112, remote UE 112 may implicitly or explicitly indicate the decision to relay UE 110 and/or the network. For example, the RRC suspend request from remote UE 112 to the network maybe understood by the network in an implicit way, as the acceptance of remote UE 112 to pause the L2 relay link and the L2 relay connection.

The L2 relay connection between relay UE 110 and remote UE 112 may remain in the paused state while the L2 pause timer is running. Remote UE 112 may continue in the paused L2 state as long as the L2 pause timer is running. The L2 pause timer may be restarted, if needed, and there is no uplink and/or downlink data for remote UE 112.

Upon expiry of the L2 pause timer, and if there is uplink and/or downlink data for remote UE 112, remote UE 112 may, at step 230, re-establish Uu or perform relay reselection. Alternatively, remote UE 112 may setup and switch to a L3 relay connection, either with existing relay UE 110 or a new relay which has been found through reselection. In some embodiments, the L3 session establishment may be triggered in parallel, once the command is sent to remote UE 112 to switch to the inactive state. Alternatively, the L3 session establishment maybe triggered while the L2 pause timer is running. In another embodiment, the L3 session establishment maybe triggered when L2 pause timer expires. In yet another embodiment, the L3 session establishment may be triggered in parallel, once the command is sent to remote UE 112 by relay UE 110 when relay UE 110 performs the handover.

On the other hand, if the L2 pause timer expires and/or there is no uplink and/or downlink data for remote UE 112, remote UE 112 may, at step 240, release the L2 relay connection and enter RRC idle state, such as RRC_IDLE or conventional RRC_INACTIVE state without applying e.g. any L2 pause state.

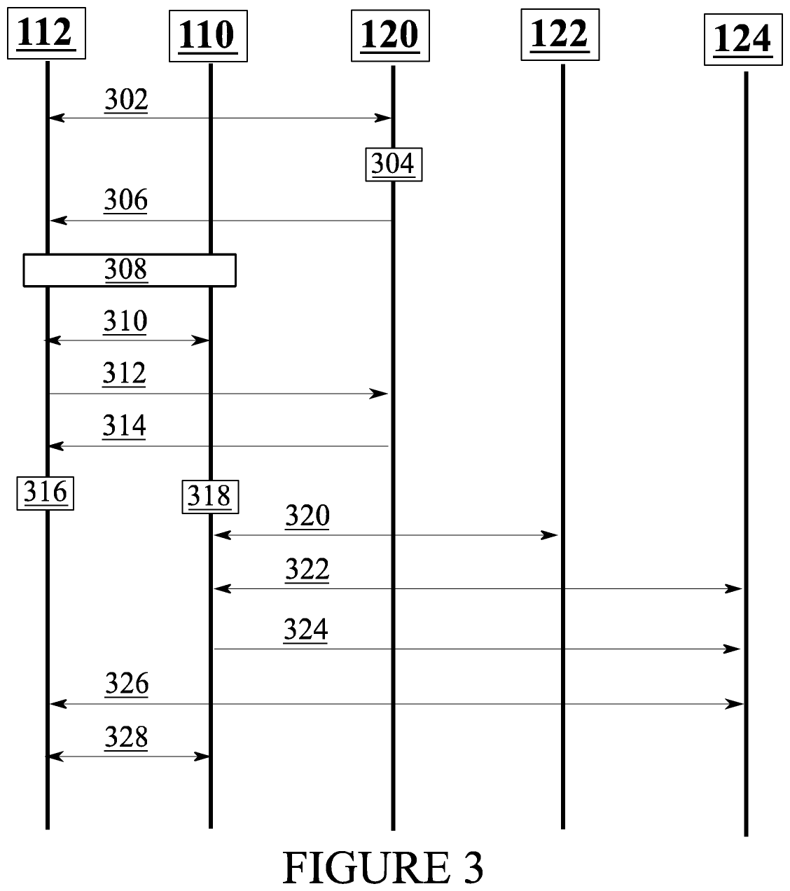

FIG. 3 illustrates a signalling graph in accordance with at least some example embodiments. With reference to FIG. 1, on the vertical axes are disposed, from the left to the right, remote UE 112, relay UE 110, BS 120, target BS 122 for a handover and another target BS 124 for a subsequent handover. Time advances from the top towards the bottom.

At step 302, remote UE 112 may communicate with serving BS 120 via relay UE 110, i.e., via a L2 relay link between remote UE 112 and BS 120. Remote UE 112 may be in a connected state at step 302 and after step 302 until remote UE 112 is transitioned from the connected state to an RRC inactive state. At step 304, serving BS 120 may determine that target BS 122 for a handover of relay UE 110 does not support L2-relaying. When current serving BS 120 of relay UE 110 is aware of the ongoing L2 relay link connection and knows that target BS 122 of relay UE 110 does not support L2-relaying, BS 120 may transmit, at step 306, an indication indicating that target 122 for the handover does not support L2-relaying.

In some embodiments, relay UE 110 may forward said indication to remote UE 112. Said indication maybe transmitted to remote UE 112 implicitly or explicitly by relay UE 110 and/or the network, such as BS 120. Alternatively, the L2 support capability of BSs may be provided/indicated to relay UE 110 and/or remote UE 112 in RNA cell lists or updates, as pre-configurations or as a new field in a handover command.

Relay UE 110 and/or remote UE 112 may determine whether to pause the L2 relay link based at least on the received indication. In accordance with the determination that the L2 relay link is paused, the L2 relay link may be paused. For instance, remote UE 112 may send a request to relay UE 110 to pause the L2 relay link, determine to transition remote UE 112 from the connected state to an inactive state after or when pausing the relay link and transmit to BS 120, RRC message to request the transition from the connected state to the inactive state. Alternatively, in accordance with the determination that the L2 relay link is not paused, remote UE 112 may terminate the L2 relay link.

Whether the data is delay sensitive or not may be considered when remote UE 110, relay UE 110 and/or the network decides to pause the L2 relay link. If the data is delay sensitive, then for example remote UE 112 might opt for other options. Also, one possibility is that the data can be prioritized and buffered at relay UE 110 in the UL and vice-versa in the DL.

The indication from relay UE 110 and/or the network to remote UE 112 may be feedback-based and implicit methods maybe used to apply specific UE behaviour. Upon receiving a command from relay UE 110, remote UE 112 may initiate the L2 pause timer and pause the on-going L2 relay link, thereby moving to a L2 pause state and providing an ACK/NACK to relay UE 110. If the NACK is received from remote UE 112, relay UE 110 may perform a re-transmission and/or trigger L3 establishment procedure of L2-to-L3 path to switch or release the PC5 link with remote UE 112. While upon sending the NACK to relay UE 110, remote UE 112 may wait for the re-transmission or perform relay reselection or Uu establishment. Upon receiving an ACK, relay UE 110 may also initiate a timer in sync with the L2 pause timer of remote UE 112. In some embodiments, the L2 pause timer may only run on remote UE 112 and relay UE 110 may estimate the duration of the L2 pause timer based on the total duration of the L2 pause timer and the time when the timer is started.

The timer and the L2 configuration in inactive state may be configured by the network and/or relay UE 110 or by jointly the network and remote UE 112. The reason to terminate the L2 relay link maybe indicated to the network. This can be optional and maybe configured by the network. In one embodiment, remote UE 110 may inform V2X/service application layer about expected service interruption (transfer the activated status of L2 pause timer to upper layers).

Upon receiving said indication by relay UE 110 and/or remote UE 112, relay UE 110 and/or remote UE 112 may decide, at step 308, to induce the inactive state, such as RRC_INACTIVE state, for remote UE 112. At step 310, the L2 relay link between relay UE 110 and remote UE 112 may be paused responsive to receiving said indication. In addition, the L2 pause timer may be started if configured.

Moreover, at step 312 relay UE 110 and/or remote UE 112, may transmit a RRC suspend request to BS 120 to request suspension of the RRC connection of remote UE 112. In some embodiments, relay UE may also request for its own RRC state transition together with the RRC suspend request of remote UE 112. The request(s) may include a new cause value indicating the L2 paused state. Subsequently, BS 120 may inform core network 130 in its RRC Inactive Transition Report that remote UE 110 and Relay UE 112 pair is paused, with a similar cause value. In some embodiments, the decision to enter the inactive state may depend on the required QoS for the ongoing data transmissions of remote UE 110, the load on relay UE 112, the load on target BS 122 and so on.

At step 314, BS 120 may transmit a RRC suspend command for remote UE 112. In some embodiments, the RRC suspend command may be transmitted jointly/in addition/separately with the said indication indicating that target BS 122 for the handover does not support L2-relaying, i.e., before any state transition is requested.

Upon receiving said indication and/or transitioning remote UE 112 to the inactive state by relay UE 110, remote UE 112 may pause the ongoing L2 relay link, i.e., the ongoing sidelink relay connection. At step 316, remote UE 112 may buffer any transmissions on the uplink on the concerned L2 relay link and, at step 318, relay UE 110 may also buffer any transmissions on the downlink for remote UE 110, on the concerned L2 relay link. Relay UE 110 and remote UE 112 may not trigger a transition to the connected state for remote UE 112, until support for L2-relaying is available from the network.

At step 320, relay UE 110 may perform a handover to target BS 122. At step 322, relay UE 110 may perform a subsequent handover to another target BS 124. If relay UE 110 is handed over, while the L2 relay link is paused, to another BS 124 which supports L2-relaying, the network may provide a L2-support notification to relay UE 110 and/or remote UE 112. Upon receiving the notification or determining that L2-relaying is supported again, relay UE 110 and/or remote UE 112 may initiate, at step 324, a quick RRC resume procedure and unpause or resume the L2 relay link. The RRC resume procedure may be restricted to only relay UE 110 and/or remote UE 112 initiated resume, and the network initiated resume may be stopped until pausing of the relay link is discontinued by relay UE 110 and/or remote UE 112 or until the L2 pause timer expires. The RRC resume request may also indicate the remaining duration of the pause timer, e.g., in addition to new type RNTIs and ID of the anchor gNB, such as BS 120.

At step 326, target BS 124 may transmit a RRC resume request/indication to remote UE 112. At step 328, remote UE 112 may resume to connected state and the L2 relay link may be resumed as well. In addition, relay UE 110 and remote UE 112 may stop the L2 pause timer if configured.

In some embodiments, the network and/or relay 110 may pause the L2 relay link, even when L2-relaying is supported by the network. This may be due to network capacity reasons or relay load etc.

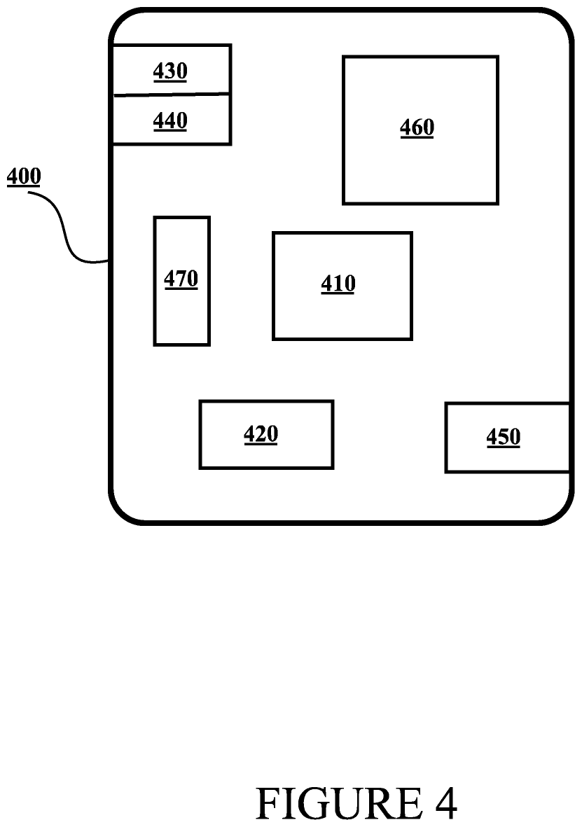

FIG. 4 illustrates an example apparatus capable of supporting at least some example embodiments. Illustrated is device 400, which may comprise, for example, relay UE 110, remote UE 112 or BS 120, or a device controlling functioning thereof, possibly when installed therein. Comprised in device 400 is processor 410, which may comprise, for example, a single- or multi-core processor wherein a single-core processor comprises one processing core and a multi-core processor comprises more than one processing core. Processor 410 may comprise, in general, a control device. Processor 410 may comprise more than one processor. Processor 410 may be a control device. Processor 410 may comprise at least one Application-Specific Integrated Circuit, ASIC. Processor 410 may comprise at least one Field-Programmable Gate Array, FPGA. Processor 410 may comprise at least one Qualcomm Snapdragon and/or Intel Atom processor. Processor 410 may comprise, for example, a Cortex-A8 processing core manufactured by ARM Holdings or a Steamroller processing core produced by Advanced Micro Devices Corporation. Processor 410 may be means for performing method steps in device 400, such as determining, causing transmitting and causing receiving. Processor 410 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a network function, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 400 may comprise memory 420. Memory 420 may comprise random-access memory and/or permanent memory. Memory 420 may comprise at least one RAM chip. Memory 420 may comprise solid-state, magnetic, optical and/or holographic memory, for example. Memory 420 may be at least in part accessible to processor 410. Memory 420 may be at least in part comprised in processor 410. Memory 420 may be means for storing information. Memory 420 may comprise computer instructions that processor 410 is configured to execute. When computer instructions configured to cause processor 410 to perform certain actions are stored in memory 420, and device 400 overall is configured to run under the direction of processor 410 using computer instructions from memory 420, processor 410 and/or its at least one processing core may be considered to be configured to perform said certain actions. Memory 420 may be at least in part comprised in processor 410. Memory 420 may be at least in part external to device 400 but accessible to device 400.

Device 400 may comprise a transmitter 430. Device 400 may comprise a receiver 440. Transmitter 430 and receiver 440 may be configured to transmit and receive, respectively, information in accordance with at least one cellular or non-cellular standard. Transmitter 430 may comprise more than one transmitter. Receiver 440 may comprise more than one receiver. Transmitter 430 and/or receiver 440 may be configured to operate in accordance with Global System for Mobile communication, GSM, Wideband Code Division Multiple Access, WCDMA, Long Term Evolution, LTE, and/or 5G/NR standards, for example.

Device 400 may comprise a Near-Field Communication, NFC, transceiver 450. NFC transceiver 450 may support at least one NFC technology, such as Bluetooth, Wibree or similar technologies.

Device 400 may comprise User Interface, UI, 460. UI 460 may comprise at least one of a display, a keyboard, a touchscreen, a vibrator arranged to signal to a user by causing device 400 to vibrate, a speaker and a microphone. A user may be able to operate device 400 via UI 460, for example to accept incoming telephone calls, to originate telephone calls or video calls, to browse the Internet, to manage digital files stored in memory 420 or on a cloud accessible via transmitter 430 and receiver 440, or via NFC transceiver 450, and/or to play games.

Device 400 may comprise or be arranged to accept a user identity module 470. User identity module 470 may comprise, for example, a Subscriber Identity Module, SIM, card installable in device 400. A user identity module 470 may comprise information identifying a subscription of a user of device 400. A user identity module 470 may comprise cryptographic information usable to verify the identity of a user of device 400 and/or to facilitate encryption of communicated information and billing of the user of device 400 for communication effected via device 400.

Processor 410 may be furnished with a transmitter arranged to output information from processor 410, via electrical leads internal to device 400, to other devices comprised in device 400. Such a transmitter may comprise a serial bus transmitter arranged to, for example, output information via at least one electrical lead to memory 420 for storage therein. Alternatively to a serial bus, the transmitter may comprise a parallel bus transmitter. Likewise processor 410 may comprise a receiver arranged to receive information in processor 410, via electrical leads internal to device 400, from other devices comprised in device 400. Such a receiver may comprise a serial bus receiver arranged to, for example, receive information via at least one electrical lead from receiver 440 for processing in processor 410. Alternatively to a serial bus, the receiver may comprise a parallel bus receiver.

Device 400 may comprise further devices not illustrated in FIG. 4. For example, where device 400 comprises a smartphone, it may comprise at least one digital camera. Some devices 400 may comprise a back-facing camera and a front-facing camera, wherein the back-facing camera may be intended for digital photography and the front-facing camera for video telephony. Device 400 may comprise a fingerprint sensor arranged to authenticate, at least in part, a user of device 400. In some embodiments, device 400 lacks at least one device described above. For example, some devices 400 may lack a NFC transceiver 450 and/or user identity module 470.

Processor 410, memory 420, transmitter 430, receiver 440, NFC transceiver 450, UI 460 and/or user identity module 470 may be interconnected by electrical leads internal to device 400 in a multitude of different ways. For example, each of the aforementioned devices may be separately connected to a master bus internal to device 400, to allow for the devices to exchange information. However, as the skilled person will appreciate, this is only one example and depending on the embodiment various ways of interconnecting at least two of the aforementioned devices may be selected without departing from the scope of the embodiments.

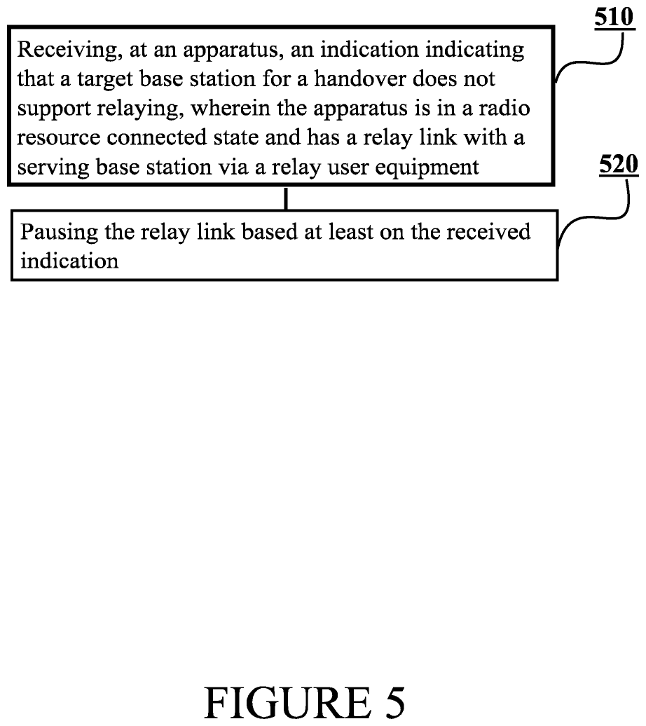

FIG. 5 is a flow graph of a first method in accordance with at least some example embodiments. The phases of the illustrated first method may be performed by remote UE 112 or a device controlling functioning thereof, possibly when installed therein.

The first method may comprise, at step 510, receiving, at an apparatus, an indication indicating that a target base station for a handover does not support relaying, wherein the apparatus is in a radio resource control connected state and has a relay link with a serving base station via a relay user equipment. The first method may further comprise, at step 520, pausing the relay link based at least on the received indication.

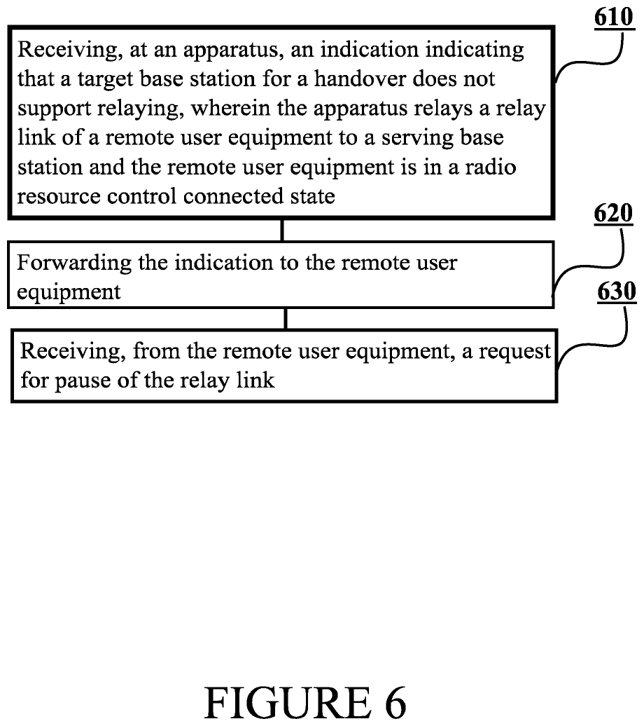

FIG. 6 is a flow graph of a second method in accordance with at least some example embodiments. The phases of the illustrated second method may be performed by relay UE 110 or a device controlling functioning thereof, possibly when installed therein.

The second method may comprise, at step 610, receiving, at an apparatus, an indication indicating that a target base station for a handover does not support relaying, wherein the apparatus relays a relay link of a remote user equipment to a serving base station and the remote user equipment is in a radio resource control connected state. The second method may further comprise, at step 620, forwarding the indication to the remote user equipment. Finally, the second method may comprise, at step 630, receiving, from the remote user equipment, a request for pause of the relay link.

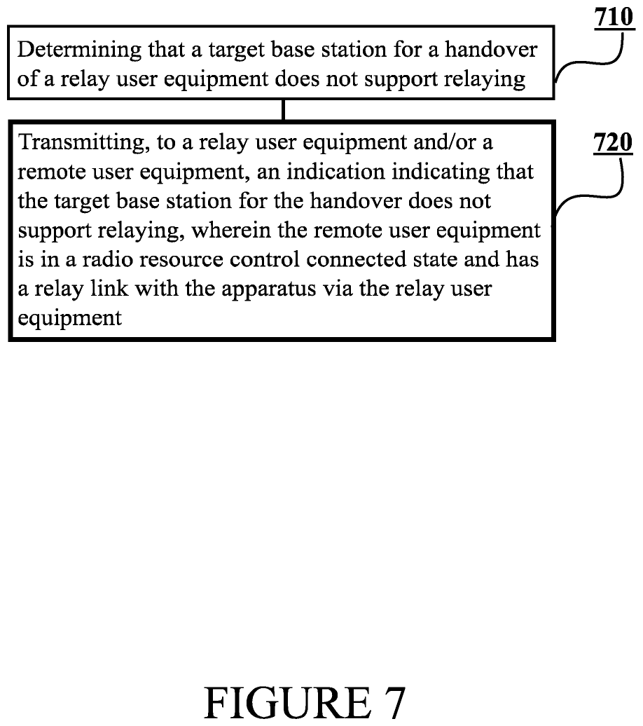

FIG. 7 is a flow graph of a third method in accordance with at least some example embodiments. The phases of the illustrated third method may be performed by BS 120 or a device controlling functioning thereof, possibly when installed therein.

The third method may comprise, at step 710, determining that a target base station for a handover of a relay user equipment does not support relaying. Also, the third method may comprise, at step 720, transmitting, to a relay user equipment and/or a remote user equipment, an indication indicating that the target base station for the handover does not support relaying, wherein the remote user equipment is in a radio resource control connected state and has a relay link with the apparatus via the relay user equipment.

It is to be understood that the example embodiments disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular example embodiments only and is not intended to be limiting.

Reference throughout this specification to one example embodiment or an example embodiment means that a particular feature, structure, or characteristic described in connection with the example embodiment is included in at least one example embodiment. Thus, appearances of the phrases “in one example embodiment” or “in an example embodiment” in various places throughout this specification are not necessarily all referring to the same example embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various example embodiments and examples may be referred to herein along with alternatives for the various components thereof. It is understood that such example embodiments, examples, and alternatives are not to be construed as de facto equivalents of one another, but are to be considered as separate and autonomous representations.

In an example embodiment, an apparatus, comprising for example relay UE 110, remote UE 112 or BS 120, may further comprise means for carrying out the example embodiments described above and any combination thereof. The apparatus may be an apparatus of a cellular communication network, such as a 5G network, and comprise means for operating in the cellular communication network.

In an example embodiment, a computer program comprising instructions which, when the program is executed by a computer, cause the computer to carry out a method in accordance with the example embodiments described above and any combination thereof. In an example embodiment, a computer program product, embodied on a non-transitory computer readable medium, may be configured to control a processor to perform a process comprising the example embodiments described above and any combination thereof.

In an example embodiment, an apparatus, comprising for example relay UE 110, remote UE 112 or BS 120, may further comprise at least one processor, and at least one memory including computer program code, wherein the at least one memory and the computer program code are configured to, with the at least one processor, cause the apparatus at least to perform the example embodiments described above and any combination thereof. The apparatus may be an apparatus of a cellular communication network, such as a 5G network, and configured to operate in the cellular communication network.

Furthermore, the described features, structures, or characteristics may be combined in any suitable manner in one or more example embodiments. In the preceding description, numerous specific details are provided, such as examples of lengths, widths, shapes, etc., to provide a thorough understanding of example embodiments of the present disclosure. One skilled in the relevant art will recognize, however, that the invention may be practiced without one or more of the specific details, or with other methods, components, materials, etc. In other instances, well-known structures, materials, or operations are not shown or described in detail to avoid obscuring aspects of the present disclosure.

While the forgoing examples are illustrative of the principles of the example embodiments in one or more particular applications, it will be apparent to those of ordinary skill in the art that numerous modifications in form, usage and details of implementation may be made without the exercise of inventive faculty, and without departing from the principles and concepts of embodiments of the present disclosure. Accordingly, it is not intended that the present disclosure be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

The expression “at least one of A or B” in this document means A, or B, or both A and B.

### INDUSTRIAL APPLICABILITY

At least some example embodiments find industrial application in cellular communication networks, such as 5G networks, and possibly in other cellular communication networks in the future as well.

### Acronyms List

3GPP 3rd Generation Partnership Project
AMF Access and Mobility Management Function
BS Base Station
GSM Global System for Mobile communication
ID Identity
IoT Internet of Things
LTE Long-Term Evolution
M2M Machine-to-Machine
NFC Near-Field Communication
NR New Radio
PDB Packet Delay Budget
PQI PC5 QoS Identifier
RAN Radio Access Network
RAT Radio Access Technology
RNA RAN Notification Area
RNTI Radio Network Temporary Identifier
RRC Radio Resource Control
QFI QoS Flow Identifier
QoS Quality of Service
SIB System Information Block
SL Sidelink
UE User Equipment
UI User Interface
UPF User Plane Function
V2X Vehicle-to-Everything
WCDMA Wideband Code Division Multiple Access
WiMAX Worldwide Interoperability for Microwave Access
WLAN Wireless Local Area Network

REFERENCE SIGNS LIST

| | |
|---|---|
| 105, 115 | Air interfaces |
| 110 | Relay UE |
| 112 | Remote UE |
| 120 | Serving BS |
| 122 | Target BS for a first handover |
| 124 | Target BS for a second handover |
| 125, 135 | Wired interfaces |
| 130 | Core network |
| 210-240 | Steps in FIG. 2 |
| 302-328 | Steps in FIG. 3 |
| 400-470 | Structure of the apparatus of FIG. 4 |
| 510-520 | Phases of the method in FIG. 5 |
| 610-630 | Phases of the method in FIG. 6 |
| 710-720 | Phases of the method in FIG. 7 |

1. An apparatus, comprising:
at least one processor and at least one memory storing instructions which, when executed, cause the at least one processor to:
receive an indication indicating that a target base station of the apparatus for a handover does not support relaying, wherein the apparatus is in a radio resource control connected state and has a relay link with a serving base station via a relay user equipment; and
pause the relay link based at least on the received indication.

2. The apparatus according to claim 1, wherein pausing the relay link comprises:
transmitting to the serving base station, a radio resource control message to request a transition from the radio resource control connected state to a radio resource control inactive state, wherein a context of the apparatus in the radio resource control inactivate state is associated with the relay user equipment and the relay link; and
transitioning from the radio resource control connected state to the radio resource control inactive state.

3. The apparatus according to claim 1, wherein the instructions further cause the at least one processor to:
receive a radio network temporary identifier from the serving base station, wherein the radio network temporary identifier is to be used to identify a pair comprising the apparatus and the relay user equipment.

4. The apparatus according to claim 2, wherein the instructions further cause the at least one processor to:
buffer uplink data while the relay link is paused.

5. The apparatus according to claim 2, wherein the instructions further cause the at least one processor to:
start a timer when pausing the relay link, wherein the timer is configured by the relay user equipment or the serving base station.

6. The apparatus according to claim 2, wherein the instructions further cause the at least one processor to:
receive an indication indicating that a subsequent target base station for a subsequent handover supports relaying; and
resume the relay link with the subsequent target base station via the relay user equipment by using the allocated radio network temporary identifier;

7. The apparatus according to claim 6, wherein the instructions further cause the at least one processor to:
stop the timer upon receiving the indication indicating that the subsequent target base station for the subsequent handover supports relaying when the timer is running.

8. The apparatus according to claim 5, wherein the instructions further cause the at least one processor to:
request the relay user equipment or the serving base station to extend the timer.

9. The apparatus according to claim 5, wherein the instructions further cause the at least one processor to:
upon expiration of the timer, terminate the relay link.

10. The apparatus according to claim 1, wherein the instructions further cause the at least one processor to:
terminate the relay link based at least on the received indication indicating that the target base station for the handover does not support relaying.

11. The apparatus according to claim 9, wherein the termination of the relay link comprises at least one of the following:
initiating a re-selection of another relay user equipment;
establishing a direct connection between the apparatus and a base station; and
transitioning to a radio resource control idle state.

12. An apparatus, comprising:
at least one processor and at least one memory storing instructions which, when executed, cause the at least one processor to:
receive, from a serving base station, an indication indicating that a target base station of the apparatus for a handover does not support relaying, wherein the apparatus relays a relay link of a remote user equipment to the serving base station and the remote user equipment is in a radio resource control connected state;
forward the indication to the remote user equipment; and
receive, from the remote user equipment, a request for pause of the relay link.

13. The apparatus according to claim 12, the pause of the relay link comprising:
transitioning the remote user equipment from the radio resource control connected state to a radio resource control inactive state, wherein a context of the remote user equipment in the radio resource control inactivate state is associated with the apparatus and the relay link.

14. The apparatus according to claim 12, wherein the instructions further cause the at least one processor to:
transmit, to the serving base station, a radio resource control message to request for transitioning the remote user equipment from the radio resource control connected state to the radio resource control inactive state.

15. The apparatus according to claim 12, wherein the instructions further cause the at least one processor to:
receive a radio network temporary identifier from the serving base station, wherein the radio network temporary identifier is to be used to identify a pair comprising the apparatus and the remote user equipment.

16. An apparatus, comprising:
at least one processor and at least one memory storing instructions which, when executed, cause the at least one processor to:
determine that a target base station for a handover of a relay user equipment does not support relaying; and
transmit, to a relay user equipment and/or a remote user equipment, an indication indicating that the target base station for the handover does not support relaying, wherein the remote user equipment is in a radio resource control connected state and has a relay link with the apparatus via the relay user equipment.

17. The An apparatus according to claim 16, wherein the instructions further cause the at least one processor to:
receive a radio resource control message to request a state transition for the remote user equipment from the radio resource control connected state to a radio resource control inactive state;
allocate a radio network temporary identifier, wherein the radio network temporary identifier is to be used to identify a pair comprising the remote user equipment and the relay user equipment; and
send the radio network temporary identifier to the relay user equipment and/or the remote user equipment.
